(19) United States
(12) Patent Application Publication
(10) Pub. No.: US 2008/0195307 A1
(43) Pub. Date: Aug. 14, 2008

(54) Method of Establishing Neighboring Points for a Digital Road Network System

(76) Inventors: Michel Raynaud, Fontenay-Sous-Bois (FR); Mouna Bouslouk, Paris (FR)

Correspondence Address: BUCHANAN, INGERSOLL & ROONEY PC, POST OFFICE BOX 1404, ALEXANDRIA, VA, 22313-1404, US

(21) Appl. No.: 11/665,652

(22) PCT Filed: Oct. 13, 2005
(86) PCT No.: PCT/EP2005/011006

§ 371 Date: Nov. 19, 2007

(30) Foreign Application Priority Data
Oct. 18, 2004 (FR) 04/11028

(51) Int. Cl. G01C 21/34; G06F 15/16

(52) U.S. Cl. 701/202; 709/227

(57) ABSTRACT

A method of establishing neighboring points for a digital road network system stored on a storage medium and comprising a plurality of segments and indications of the position of these segments, in which, in order to link a given neighboring point with a given intersection:
(a) the class of said intersection (CC) is established;
(b) it is verified whether the class (CC) of this intersection is greater than a given intersection recognition threshold (SPCC);
(c) an identification is made of the selectable surrounding neighboring points (PV), which are located within a given radius of the intersection and which have a range or threshold of the minimum required value (SPV);
(d) the PV closest to the intersection is selected and a link is created between the data corresponding to said intersection and those of said neighboring point (PV).

The present invention relates to a method of establishing relationships or neighboring points for a digital road network system enabling the identification of the neighboring point located closest to a given intersection and the creation of a link between the data corresponding to this intersection and those of this neighboring point. The neighborhood relationships thus established can be used to complete the guidance information used for producing routes intended for users of road or other type of networks.

In the past, the cartographer, using a paper map, showed the proximity data of a given town with respect to the surrounding road network. Hence, some digital road network databases still include such indications. But keeping such data up to date is very tedious and costly, due to the expansion of built-up areas and/or changes in the road network. Furthermore, current data sources, for the most part on a large scale (i.e. a scale including a high level of detail), do not include such indications. Taking into account the enormous scope that this would represent, given the number of objects in current road databases, it is inconceivable to manually enter information or update these databases in order to provide them with the data relating to proximity.

Thus, most databases do not contain indications relating to the environment, especially regarding the proximity or neighborhood of places easily visible or identifiable along a route actually being traveled. But such indications are very useful for enabling the user to make a link between the road map of a route and what he sees or glimpses when he drives his vehicle along the route. For example, it is practical to know that the intersection where the next route change will take place is close to a given place, easy to locate from the road traveled. This may be a locality, such as a village, a town, etc., or a clearly visible tourist site, a natural site such as a mountain, a waterfall, a lake, etc.

Such proximity indications can also be useful as progress markers along a route.

In order to remedy these drawbacks, the present invention provides a method of establishing neighboring points for a digital road network system stored on a storage medium and comprising a plurality of segments and indications of the position of these segments, said segments being capable of being combined in piecing together a road network so as to form portions of roads and intersections, in which, in order to link a given neighboring point with a given intersection:

(a) the class of said intersection (CC) is established;

(b) it is verified whether the class (CC) of this intersection is greater than a given intersection recognition threshold (SPCC);

(c) an identification is made of the selectable surrounding neighboring points (PV), which are located within a given radius of the intersection and which have a range or threshold of the minimum required value (SPV);

(d) the PV closest to the intersection is selected and a link is created between the data corresponding to said intersection and those of said neighboring point (PV).

Such a method can be used either to set up a new digital road network database, using prior processing to create data relating to proximity or neighborhood indications over the whole network, or to dynamically create (on request) such indications, e.g. when establishing a given route in order to piece them together on a route sheet. According to a variant embodiment, a mixed mode is provided, in which, for certain segments (preferably the most followed or most frequented), the neighborhood indications are pre-established, and for the other segments (preferably the least followed or least frequented), the neighborhood indications are established on request, e.g. when establishing a given route.

According to an advantageous embodiment, the threshold (SPV) depends on the class (CC) of the intersection such that the higher the class, the higher the threshold (SPV) is. In other words, the more important the intersection is, the more important the aforementioned neighboring point (PV) must also be.

According to an advantageous embodiment, the maximum radius of a neighboring point (PV) depends on the one hand on the range of this point, and on the other hand on the class (CC), such that, for a given class value (CC), the more the range of the neighboring point (PV) increases, the more the maximum radius increases, and for a given neighboring point (PV) range, the more the class (CC) increases, the more the maximum radius increases. In other words, the more important the intersection is, the farther the aforementioned neighboring point (PV) can be.

Advantageously, the class of an intersection (CC) is the average of the classes of the three main segments. According to various variant embodiments, the class of an intersection may also correspond to the average of all the segments of this intersection, or to the average of the two main segments, or more simply to the class of the main segment.

Advantageously, the network also includes nodes, which can be used in a representation of the road network to join together a plurality of segments.

Advantageously, a neighboring point is a locality (town, village, market town, etc.) and its range is established according to importance, judged by the population, administrative rank and resources (hotel, tourist) of said locality. According to various variant embodiments, a neighboring point can also be a tourist site, a geological or archaeological site, a noteworthy monument or building, or any other landmark that is easy to identify when moving along a main highway, enabling the user to find his bearings with a minimum risk of error.

The invention also provides software comprising code elements programmed for implementing the method as claimed in claims 1 to 6, when said software is loaded into a computer system and executed by said computer system.

This software may be in the form of a product recorded onto a machine-readable medium, comprising programmed code elements as disclosed above.

According to another aspect, the invention further provides a method of setting up a route sheet, for drawing up a list of instructions enabling a user to travel along a route based on indications provided by this list, in which the instructions relating to the changes in direction to be made at intersections are completed by this intersection's neighboring points, the neighboring points (PV) being established using the previously disclosed method.

Advantageously, the points enabling said route to be established are identified by selecting a first modeling element of the road network, preferably a node, close to the point of departure, and a second modeling element of the road network, preferably a node, close to the point of arrival, identifying a plurality of routes, each consisting of a plurality of route elements connected from the first element to the second element, and searching for at least one intermediate element for each of said routes in said set of road network modeling elements.

According to an advantageous embodiment, said plurality of routes is determined from a DIJKSTRA algorithm.

According to another advantageous embodiment, said plurality of routes is determined from a FORD algorithm.

The invention also provides software comprising code elements programmed for implementing the previously disclosed method, when said software is loaded into a computer system and executed by said computer system.

This software may be in the form of a product recorded onto a machine-readable medium, comprising programmed code elements as disclosed above.

According to another aspect, the invention finally provides a route calculation device, comprising:
a data input unit, for receiving the data associated with a point of departure and those associated with a point of arrival;
access to a storage unit comprising a set of road network modeling elements;
a calculation unit designed for:
   identifying a plurality of routes enabling each to connect the points of departure and arrival;
   establishing at least one neighboring point (PV) for at least one intersection.

Advantageously, said device can be used especially to produce and put together the data necessary for drawing up a route sheet including therein at least one neighboring point (PV) in association with at least one intersection.

Said device preferably includes a guidance unit, designed to generate guidance information as a function of the mapping elements of the selected route.

The invention also provides a computer system comprising a device as previously disclosed in the foregoing description.

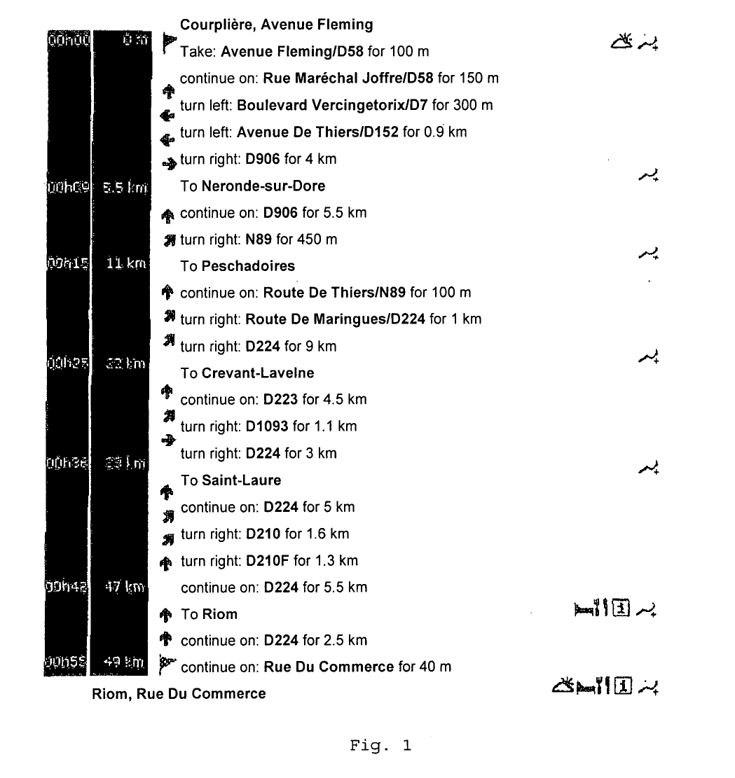

All the details of embodiment are given in the description that follows, completed by FIGS. 1 to 4 in which:

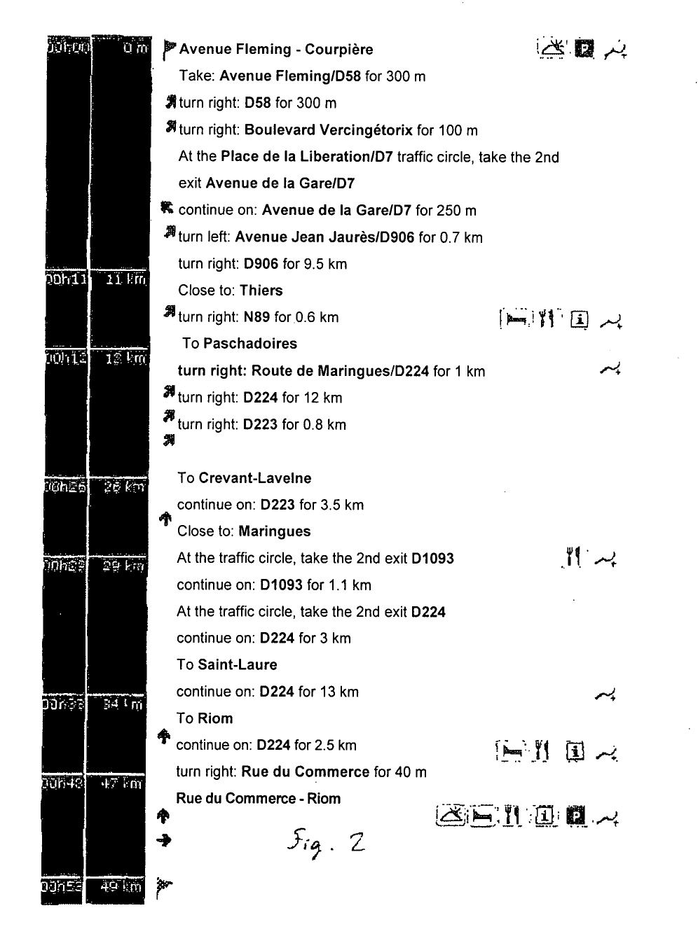

FIGS. 1 and 2 show examples of route sheets for a route from Coupiére to Riom: the route sheet in FIG. 1 does not include any neighborhood indication whereas the route sheet in FIG. 2 contains two neighborhood indications (close to Thiers and close to Maringues).

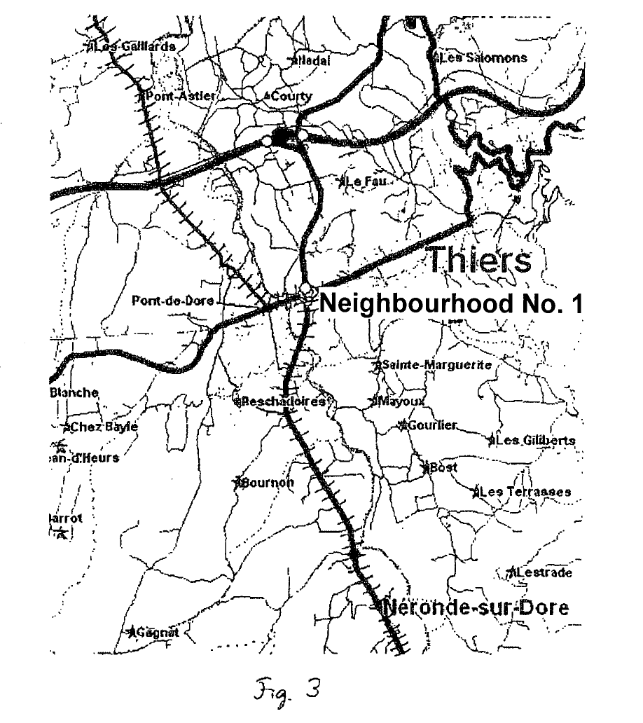

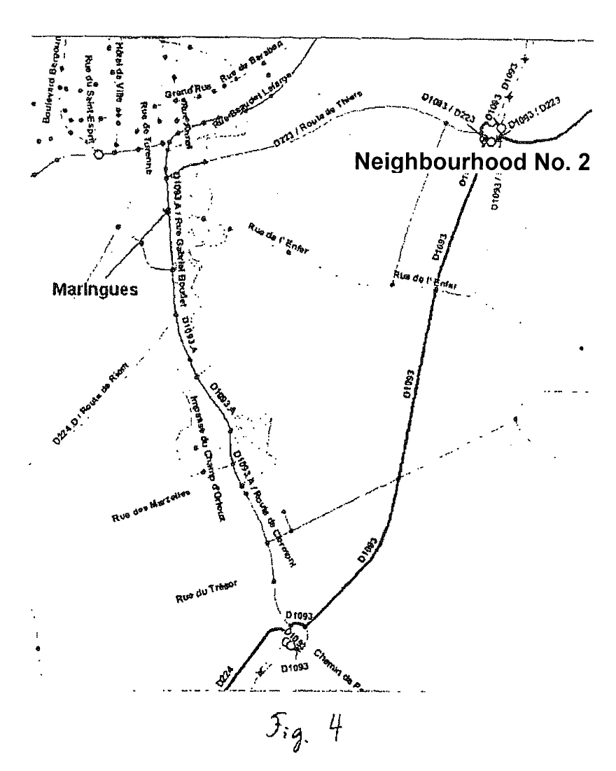

FIGS. 3 and 4 illustrate portions of the route corresponding to the route sheet in FIG. 2: FIG. 3 shows a neighboring point near Thiers; FIG. 4 shows that near Maringues.

In the present description, the following terms are used in particular with the following meanings:

“Node” refers to a point of intersection between a first mapping or road network (or other network) element and a second element of such a network, in particular the intersection between a plurality of roadways. A node also refers to a point of physical or qualitative change in a segment, as for example passing from two to three lanes, a change in speed limit, an area of (even temporary) road works, a break point such as a border, etc.

“Segment” refers to a portion of road between two nodes.

“Intersection” refers to an intersection of several roads at the same level.

“Route” refers to a subset of points stemming from the modeling elements of a road network, creating a link between the data enabling them to model or represent a journey or path on said road network used to connect a point of departure and a point of arrival. This subset is composed of data relating to the segments used to connect the departure and arrival. Data relating to the segments is understood to mean the identifications, lengths and spatial coordinates of the segments.

This subset can be used to represent said route in different forms, e.g. by means of a graphical representation, preferably in the form of a map including the point of departure, the point of arrival and the segments forming said route, or in the form of a “route sheet” or list of instructions, comprising a listing or series of instructions either written or represented by pictograms, explaining to a possible driver of a vehicle the different steps to follow for taking said route.

In the following paragraphs, the neighborhood relationships are treated first in a general way, then using an example illustrated with the aid of FIGS. 1 to 4.

Neighborhood, as its name indicates, is a proximity relationship between an intersection and a locality. This relationship is advantageously used in the context of a route description for:
approximately locating a particular point of this route: fork, toll, radar control, transfer;
forming a marker in the progress of the route: particularly in the case of long freeway journeys.

When a particular event occurs within the urban area (the commonly adopted international definition of an urban area is an area where no dwelling is more than 200 meters away from the nearest other dwelling) of a locality, it is described as occurring “in” the locality, without ambiguity over the name to be mentioned just to be as accurate as possible (down to the name of the hamlet if necessary) insofar as this accuracy is observable on the ground.

Contrariwise, neighborhoods apply to all the portions of a route that are located in a rural area (i.e. which are not located in the urban area of a locality). Clearly therefore the name of the locality to be mentioned must be chosen with care. It does not necessarily have to be the locality on whose territory it is located: e.g. another locality may be physically closer, and therefore more relevant to mention.

The paragraphs that follow disclose the method used. First, two parameters are established which are used to set the “depth” of the search:
1. the minimum importance level of the network that is processed;
2. the minimum network of the localities whose radius is desired to be calculated.

These two settings have an impact on the number of neighborhoods calculated (setting number 1), on the accuracy (setting number 2), and on the calculation times (settings number 1 and 2).

Since the neighborhoods of interest are mainly in the portions of routes situated outside urban areas of localities, for inter-locality journeys it would seem logical for them to be restricted to the corresponding network levels (importance 12 and over).

“Intersections of interest” are considered to be (failing actual ones, case number 3):
all intersections (intersection of several roads: at least 3 segments of road converge at this point), in the commonly accepted meaning comprising at least four segments of any importance, on condition that at least three of them are of sufficient importance. Road segments closed to traffic should not, however, be considered: those of pedestrian areas are eliminated due to the fact of their low importance, but there are those of a higher importance which must also not be taken into account (e.g.: freeway connecting roads closed to traffic in normal use).
intersections in the commonly accepted meaning, comprising exactly 3 segments of sufficient importance, unless it involves a divided highway. Divided highways are characterized by the passage of a two-way segment to/from two one-way segments, the three having the same importance. Among those which fulfill the preceding condition, traffic circles, which are considered of interest, should not be mixed up with divided highways. For this, it is sufficient to check whether one of the three segments forms part of a traffic circle. If this is the case (one of the three segments forms part of a traffic circle), it does not involve a divided highway, therefore the intersection is of interest to us, if not, the intersection does not interest us.
nodes comprising at least two segments, if one of them is not a road: we are then in the presence of a transfer point (rail/road or boat/road change).

The importance, termed the class, of an intersection is judged by the importance of all the segments that converge there, and not only that of the most important road: all the intersections of Route Nationale 4 (main highway leading from Paris to Strasbourg) are not of the same class and do not therefore merit the same treatment.

If we take the three most important incident segments, we find not only the importance of the main road but also that of the most important road that it meets. An average can then be calculated, converted into an intersection class via the following correspondence:

| | average of the 3 + large | |
|---|---|---|
| Class | segments | example |
| 1 | m < 10 | local network (mainly urban) |
| 2 | 10 <= m < 12 | local network |
| 3 | 12 <= m < 14 | intersection of feeders of |
| | | Joinville interchange with D60 |
| 4 | 14 <= m < 16 | N4 × D982 intersection (Vitry- |
| | | le-François) |
| 5 | 16 <= m < 18 | N4 × N44 intersection (Vitry- |
| | | le-François) |
| 6 | 18 <= m < 20 | freeway junction |

The greater the intersection class, the greater the minimum importance (range) of the locality to be mentioned, in order to ensure that an important intersection will not be marked as neighboring a locality of minor importance, not observable “on the ground”, from the network in question. This does not mean, however, that calculating neighborhoods is wanted on all localities: in practice, the constraints of processing time above all determine the level at which to stop, bearing in mind that the most important localities are the ones to begin with. The minimum importance required according to intersection class is summarized in the table below:

| Class | Min. | imp. of loc. |
|---|---|---|
| 1 | 0 | local network (mainly urban) |
| 2 | 1 | local network |
| 3 | 2 | intersection of connecting feeders of |
| | | the Joinville interchange with D60 |
| 4 | 3 | N4 × D982 intersection (Vitry-le- |
| | | François) |
| 5 | 4 | N4 × N44 intersection (Vitry-le- |
| | | François) |
| 6 | 5 | |
| 7 | 6 | BEAUNE freeway junction |

The maximum radius of a locality is proportional to its importance. The radius may be either of the “as the crow flies” type (the fastest to calculate, but undoubtedly the least relevant), or calculated via the route, according to a time or km criterion. The km criterion can reduce certain aberrations that are likely to occur in “as the crow flies” mode.

Proximity is calculated based on the limit of the urban area if it exists, and, failing an urban area, from the center of the locality. In the latter case, the absolute limits must be increased. When the urban area extends beyond the administrative limits, the propagation calculation is done from the administrative limits.

Examples of proposed absolute limits:

| Range | km |
|---|---|
| 2 | 0.75 |
| 3 | 1.5 |
| 4 | 2.5 (Joinville-52) |
| 5 | 5 (Vitry-le-François) |
| 6 | 10 (example: Sens) |
| 7 | 15 |
| 8 | 20 (example: Orléans) |
| 9 | 25 (example: Nantes, Berlin, Paris, etc.) |

Whilst remaining within the limits set in the previous paragraph, the greater the importance of the intersection, the greater the distance from the mentioned locality can be. In general, class 1 intersections (local intersections) are only indicated at a very short distance from the locality. More important class intersections are indicated at an increasingly greater distance from the locality, whilst respecting the set limit, which leads to neutralizing a part of the table and that of the point above.

The resulting table is shown below:

| Range | cl 1 | cl 2 | cl 3 | cl 4 | cl 5 | cl 6 | cl 7 | |
|---|---|---|---|---|---|---|---|---|
| 2 | 0.25 | 0.50 | 0.75 | NO | NO | NO | NO | |
| 3 | 0.30 | 0.60 | 0.90 | 1.5 | NO | NO | NO | |
| 4 | 0.40 | 0.70 | 1.00 | 1.7 | 2.5 | NO | NO | (Joinville- |
| | | | | | | | | 52) |
| 5 | 0.50 | 0.80 | 1.20 | 2.3 | 3.5 | 5 | NO | |
| 6 | 0.60 | 0.90 | 1.50 | 2.5 | 4 | 6 | 10 | (e.g. Sens) |
| 7 | 0.70 | 1.00 | 1.60 | 3 | 6 | 10 | 15 | |
| 8 | 0.80 | 1.75 | 3.00 | 5 | 10 | 15 | 20 | (e.g. |
| | | | | | | | | Orléans) |
| 9 | 1.00 | 2.00 | 4.00 | 7 | 12 | 20 | 25 | (e.g. Nantes, |
| | | | | | | | | Berlin, |
| | | | | | | | | Paris, etc.) |

If choices have to be made, a few rules can be applied:
mention the nearest locality insofar as it satisfies the criterion of eligibility and the distances. This enables having a more “relevant” neighborhood (because it is nearer) in the case of very large built-up areas by preventing “core” towns from overwhelming their periphery on the small network.

In the foregoing, no distinction is made between localities according to their administrative level A8 or A9. It seems just as useful to put neighborhoods starting from A9s as A8s, given that:
A8s have a much greater “radius” than A9s (due to their greater importance “by nature”)
radial extension from A9s (districts of Paris) does not exclude radial extension from surrounding A8s (Paris). A8s and A9s are therefore to be considered separately from one another apart from when initializing the propagation procedure or when propagation from the A8 retrieves the urban segments of the set of A9s forming the A8. In the event of equality, it is the most “precise” neighborhood (that obtained from the A9) that prevails.

An example of an algorithm for choosing the most important locality is considered below:

For all the candidate localities;
calculate the propagation up to a distance of n km (n function of the range of the locality)
for each intersection encountered
   is it eligible?
   calculation of its class (if not yet done)
   determination of minimum range of the locality to be mentioned (if not yet done)
   is the locality (the one being traveled from) eligible?
      (sufficient range+distance<maximum)
   if YES: is it better placed (nearer) than that previously found?
      if YES: store the class, the range, the distance, the town in question
   go on to the next intersection
go on to the next candidate locality

It is suggested to start with the most important localities, since they are the least numerous, and have the farthest radial extension. But, given the priority given to proximity, it is useful to go down as low as processing times allow, bearing in mind that small localities have a much lesser radial extension than large ones.

Finally, let us examine some rules for the cohabitation of membership and neighborhood relationships. It may be useful to mention a neighborhood near a locality with a smaller range than that of membership: it is just as useful to know that you are in Paris near to Saint-Mandé, as to know that you are in Saint-Mandé (therefore close to Paris). These neighborhoods will involve the large peripheral network inside large towns by locating it in relation to the suburbs in the immediate vicinity.

An example of implementation of the present invention is illustrated in FIGS. 1 to 4. FIGS. 1 and 2 show examples of route sheets for a route from Courpiére to Riom. The route sheet in FIG. 1 is produced conventionally, and does not include any neighborhood indication. On the other hand, the route sheet in FIG. 2 is produced in accordance with the invention and includes two neighborhood indications (close to Thiers and close to Maringues).

These neighboring points are shown on partial views of the route in FIGS. 3 and 4. FIG. 3 shows a portion of this route (identified by a series of lines perpendicular to the road) when passing near Thiers. Moreover, it is this town that forms neighboring point #1 of this route, so that well before the intersection for taking the N89, the driver can easily see and identify Thiers whose outskirts he is approaching. It is highly probable that local signs will enable him to make out the name of this town, even if he does not know it.

He knows therefore that he must soon change route and can, thanks to this neighboring point, have an easy-to-see reference, which enables him to better anticipate the next route sheet instruction. The fact of seeing the neighboring point also has a reassuring effect on many drivers, since the driver knows that he is probably following the right road.

FIG. 4 shows the neighboring point near Maringues. The portion of route in this figure is shown by a dark line. Before reaching the traffic circle, the driver sees the locality of Maringues in front of him and on his left. He can therefore once again better anticipate the instruction or next step at the traffic circle.

The presence of neighboring points on the route sheet and on the route layouts is possible thanks to the method of establishing neighboring points according to the invention. The digital network database includes the neighboring points capable of generating such route sheets and such layouts.

All the neighboring points are stored in combination or association with one or more intersections. Thus, when generating a route, when it includes an intersection linked to a neighboring point, this point is capable of being used. It is used to generate, on a route sheet, an indication of the type “close to -neighboring point-”. The layout of this route can then display the chosen neighboring point.

According to the desired embodiment, neighborhood indications are chiefly used according to the following conditions:
either the route forks at this spot: it is then imperative to mention the neighborhood indication. This is just the case of the described examples of Thiers and Maringues.
or the mentioned neighboring point is important as such: the choice of mentioning it or not can then be according to the length of route. According to this criterion, the longer the route, the greater the emphasis must be on the importance of the neighboring point, so as not to overload the route unnecessarily. In the latter scenario, the neighboring points then have a function of marking progress along the route.

1. A method of establishing neighboring points for a digital road network system stored on a storage medium and comprising a plurality of segments and indications of the position of these segments, said segments being capable of being combined in piecing together a road network so as to form portions of roads and intersections, in which, in order to link a given neighboring point with a given intersection:
(a) the class of said intersection (CC) is established;
(b) it is verified whether the class (CC) of this intersection is greater than a given intersection recognition threshold (SPCC);
(c) an identification is made of the selectable surrounding neighboring points (PV), which are located within a given radius of the intersection and which have a range or threshold of the minimum required value (SPV);
(d) the PV closest to the intersection is selected and a link is created between the data corresponding to said intersection and those of said neighboring point (PV).

2. The method of establishing neighboring points as claimed in claim 1, characterized in that the threshold (SPV) depends on the class (CC) of the intersection such that the higher the class, the higher the threshold (SPV) is.

3. The method of establishing neighboring points as claimed in claim 1, characterized in that the maximum radius of a neighboring point (PV) depends on the one hand on the range of this point, and on the other hand on the class (CC), such that, for a given class value (CC), the more the range of the PV increases, the more the maximum radius increases, and for a given range, the more the class (CC) increases, the more the maximum radius increases.

4. The method of establishing neighboring points as claimed in claim 1, characterized in that the class of an intersection (CC) is the average of the classes of the three main segments.

5. The method of establishing neighboring points as claimed in claim 1, characterized in that the network also includes nodes, which can be used in a representation of the road network to join together a plurality of segments.

6. The method of establishing neighboring points as claimed in claim 1, characterized in that a neighboring point is a locality and its range is established according to importance, judged by the population, administrative rank and resources of said locality.

7. Software comprising code elements programmed for implementing the method as claimed in claim 1, when said software is loaded into a computer system and executed by said computer system.

8. Software in the form of a product recorded onto a machine-readable medium, comprising programmed code elements as claimed in claim 7.

9. A method of setting up a route sheet, for drawing up a list of instructions enabling a user to travel along a route based on indications provided by this list, in which the instructions relating to the changes in direction to be made at intersections are completed by this intersection's neighboring points, the neighboring points (PV) being established using the method as claimed in claim 1.

10. The method as claimed in claim 9, characterized in that the points enabling said route to be established are identified by selecting a first modeling element of the road network, preferably a node, close to the point of departure, and a second modeling element of the road network, preferably a node, close to the point of arrival, identifying a plurality of routes, each consisting of a plurality of route elements connected from the first element to the second element, and searching for at least one intermediate element for each of said routes in said set of road network modeling elements.

11. The method as claimed in claim 9, characterized in that said plurality of routes is determined from a DIJKSTRA algorithm.

12. The method as claimed in claim 9, characterized in that said plurality of routes is determined from a FORD algorithm.

13. Software comprising code elements programmed for implementing the method as claimed in claim 9, when said software is loaded into a computer system and executed by said computer system.

14. Software in the form of a product recorded onto a machine-readable medium, comprising programmed code elements as claimed in claim 13.

15. A route calculation device, comprising:
a data input unit, for receiving the data associated with a point of departure and those associated with a point of arrival;
access to a storage unit comprising a set of road network modeling elements;
a calculation unit designed for:
identifying a plurality of routes enabling each to connect the points of departure and arrival;
establishing at least one neighboring point (PV) for at least one intersection.

16. The route calculation device as claimed in claim 15, used to produce and put together the data necessary for drawing up a route sheet including therein at least one neighboring point (PV) in association with at least one intersection.

17. The route calculation device as claimed in claim 15, including a guidance unit, designed to generate guidance information as a function of the mapping elements of the selected route.

18. A computer system including a device as claimed in claim 15.
